(19) United States
(12) Patent Application Publication
(10) Pub. No.: US 2004/0126611 A1
(43) Pub. Date: Jul. 1, 2004

(54) Coated metal wire

(76) Inventors: Danny Gonnissen, Roeselare (BE); Nico Fourneau, Kluisberge (BE)

Correspondence Address: FOLEY AND LARDNER, SUITE 500, 3000 K STREET NW, WASHINGTON, DC, 20007, US

(21) Appl. No.: 10/474,423

(22) PCT Filed: Apr. 4, 2002
(86) PCT No.: PCT/EP02/03860

(30) Foreign Application Priority Data
Apr. 10, 2001 (EP) 01201316.5

(51) Int. Cl. B05D 1/18; B32B 15/08; B32B 15/02

(52) U.S. Cl. 428/626; 427/434.6; 428/653

(57) ABSTRACT

The invention relates to method for applying a sealing coating on a metal wire and to a metal wire coated with a sealing coating. The sealing coating is giving the metal wire an improved corrosion resistance. The sealing coating may further comprise one or more coloring pigments.

### FIELD OF THE INVENTION

The invention relates to a method of applying a sealing coating on a metal wire.

The invention further relates to a colored and/or corrosion resistant metal wire.

### BACKGROUND OF THE INVENTION

At present, there is a high demand in the market for colored wire. Such type of wire has to be characterised by a uniform color, it has to keep its beautiful appearance over a long period of time and at the same time it has to be characterised by a good corrosion resistance. A number of attempts have already been made to obtain a colored wire with a good corrosion resistance.

One of these attempts consists in applying a duplex coating on a steel wire by first galvanizing the steel wire and by then applying a polymer based coating, for example by extrusion, powder coating or lacquering. However, the process to manufacture this type of wires is expensive. Furthermore, by this process only thick coatings can be applied.

An alternative method comprises the application of a zinc or zinc alloy coating, followed by the application of a sealing coating, generally applied on a cold metal surface, after a prior treatment of chemical conversion, for example a chromate conversion. However, since chromium is a toxic component, high efforts are made to avoid its use.

Nowadays one tries to replace chromium by other adhesion promoters such as Ti and/or Zr salts. Also silanes are used to obtain a sufficient adhesion.

These alternatives are however expensive and up to now the performance of these adhesion promoters is not satisfactory.

### SUMMARY OF THE INVENTION

It is an object of the present invention to provide a method of applying a sealing coating on a metal wire without subjecting the metal wire to a treatment of chemical conversion before or during the application of the sealing coating.

It is another object to provide a method of manufacturing a colored metal wire in an environment friendly way without using chromium. It is a further object to provide corrosion resistant metal wires. It is a still a further object to provide metal wires in a variety of colors having a long lasting shining aspect and a good corrosion resistance.

According to a first aspect of the present invention a method of applying a sealing coating to a metal wire is provided. The sealing coating is applied from an aqueous solution. The aqueous solution is a dispersion comprising a copolymer based on an alkene and acrylic acid.

In a preferred embodiment the aqueous solution comprises a copolymer of ethylene and acrylic acid. Alternatively, other copolymers such as a copolymer of styrene and acrylic acid can be used.

By the application of the aqueous solution on the metal wire, a closed layer that can withstand aggressive environments is formed on the metal wire by copolymerisation.

The sealing coating is applied directly on the metal surface without needing the use of components that react chemically with the metal surface in order to obtain an adhesion layer. The adherence of the sealing coating to the metal wire makes a chemical conversion unnecessary.

It is important to notice that the aqueous solution comprising the copolymer based on an alkene and acrylic acid is chromium free or substantially chromium free. The aqueous solution is also free of other metals such as Zr or Ti, that are nowadays promoted to substitute chromium.

The sealing coating is giving the metal wire an improved corrosion resistance. This can be explained by the closed structure of the sealing coating and by the intrinsic inert properties of the coating.

By adding one or more coloring pigment to the aqueous solution the metal wire can be colored. This results in a metal wire which is colored and which is at the same time characterized by an improved corrosion resistance.

As coloring pigments either inorganic or organic pigments can be used. The colored metal wires obtained according to the present invention may pertain to the whole visible spectrum, from violet till red. Also luminescent pigments can be added.

Examples of a coloring pigment are phtalolcyanines. To obtain a green color for instance Cu-hexadecachlorophtalocyanine can be used.

Possibly, one or more additives such as a reducing agent, an anti-foaming agent or a dispersion agent can be added to the aqueous solution.

The aqueous solution comprising a copolymer of ethylene and acrylic acid can be applied by means of a number of different application techniques.

It can for example be applied by dipping the metal wire in the aqueous solution or by spraying the aqueous solution on the metal wire.

Preferably, the sealing coating is applied on a hot metal surface (150-350 ° C.). This high temperature of the metal wire gives rise to a good adherence of the sealing coating to the metal surface.

In an alternative process, the sealing coating is applied on a cold metal wire. In this case it can be preferred to heat the metal wire after the application of the sealing coating to further harden the coating.

In a preferred embodiment the method further comprises the application of a zinc or zinc alloy coating before the application of the sealing coating. The zinc or zinc alloy coating can be applied by any conventional technique such as hot dip, electrolysis or cladding.

As zinc alloy coating one can consider for example Zn-Fe, Zn-Ni and Zn-Al alloys. A preferred zinc alloy coating is a Zn-Al alloy coating comprising between 2 and 15% Al. Possibly, between 0.1 and 0.4% of a rare earth element such as Ce and/or La can be added in order to improve properties like fluidity and wettability of the melt.

The method according to the present invention results in a simplified process. The application of the sealing coating according to the present invention can be performed in a continuous, in-line process with other process steps such as wire drawing. By using a continuous process, the manufacturing costs are considerably reduced.

In particular a sealing coating applied from an aqueous solution comprising a copolymer based on ethylene and acrylic acid is very suitable to be applied in a continuous process at high speed. When a copolymer of ethylene and acrylic acid is applied on a hot surface no lumps are formed during the application. Furthermore, this copolymer has the advantage that it is characterised by short drying times.

The application of a zinc or zinc alloy coating, as described above, can also be performed in-line with the application of the sealing coating according to the present invention.

The method may further comprise one or more drying steps. Also these steps can be performed in a continuous, in-line process. According to a second aspect of the present invention, a metal wire coated with a sealing coating is provided. The sealing coating comprises an alkene - acrylate copolymer, such as an ethylene - acrylate copolymer or a styrene - acrylate copolymer. Possibly, the sealing coating further comprises one or more coloring pigments.

The coating according to the present invention is applicable to any metal wire. Preferred metal wires are steel wires or galvanised steel wires. The steel wires may be chosen within a high diameter range. Either steel wires with a low or a high carbon content can be considered. The steel wires can have any cross-section such as round, square, rectangular, oval or half oval cross-sections.

The sealing coating according to the present invention preferably has a thickness between 0.1 and 5 μm; more preferably the thickness is between 0.5 and 1 μm.

In one embodiment a zinc or zinc alloy coating is applied on the metal wire before the sealing coating is applied.

This zinc or zinc alloy coating has a thickness ranging preferably between 1 and 100 μm and more preferably between 1 and 50 μm, for example 5 or 20 μm.

The invention can be used for any kind of application where a metal wire such as a steel wire with an improved corrosion resistance and/or a colored surface is desired, for example for all kind of decoration, anticorrosion and identification applications.

Examples where a decorative aspect is desired are for example wires for handles of buckets or pails, wires for the closing of bottles or jars, and coat hanger wire.

Colored wires according to the present invention are also very suitable to be used for fences since they are giving a nice decorative aspect and at the same time an improved corrosion resistance. They can for example be used as barbed wire, for knotted fences, for welded fences,...

Structures comprising a number of metal wires according to the present invention are described below.

A further application of wires according to the present invention is for the manufacturing of springs.

Furthermore the wires are suitable for al kind of identification purposes, for example for filament identification in cables, for identification of springs or for applications where the visibility of the wire is important, such as vineyard wire.

According to a third aspect of the present invention a structure comprising a number of colored wires as described above is provided. The structure may for example comprise a welded, woven or braided structure.

Wires according to the present invention can be used in wire beads for reinforcing internal or external corners of a wall or for reinforcing window or door openings. Such wire beads are sold by the applicant under the trademark WIDRA®.

### DESCRIPTION OF THE PREFERRED EMBODIMENTS OF THE INVENTION

Although the sealing coating of the present invention can be applied to any metal wire, the following example is limited to the application of a sealing coating on a galvanised steel wire.

A steel wire according to the invention can be manufactured as follows: Starting material is a low carbon wire rod with a diameter of about 5.5 mm. This wire rod is drawn either to an intermediate diameter or to the final diameter. Subsequently, the drawn wire is subjected to a heat treatment and is hot dip galvanized at this intermediate or final diameter. The zinc coated wire can be further drawn to its final diameter in case of an intermediate drawing step. The zinc coating has for example a thickness of 15 μm.

The sealing coating is for example applied by passing the hot wire (160-300 ° C.) immediately after galvanising through a bath comprising an aqueous solution of a copolymer of ethylene and acrylic acid. The high temperature of the wire gives rise to an immediate adherence of the sealing coating to the wire surface and the remnant heat in the wire is sufficient to dry the coating without the use of an extra drying step. This has a considerable influence on the costs since a drying equipment is not necessary. As the wire heats the sealant bath, a performant cooling system may be required for keeping the bath temperature below the boiling point and preferably below 50 ° C.

The above described colored wire is characterised by a long lasting shining aspect and by a high corrosion resistance.

To evaluate the corrosion resistance, the wire is subjected to a corrosion test. The above described wire, a hot dip galvanised steel wire having a zinc coating of 15 μm on which a sealing coating with a thickness of 1 μm is applied is subjected to a neutral salt spray test (ISO 9227). 5% dark brown rust (DBR) is observed after 400 hours. When a steel wire having only a zinc coating of 15 μm is subjected to the same spraying test, 5% DBR is already observed after 100 hours. This means that by using a colored wire according to the present invention, the formation of 5% DBR is retarded 4 times compared with a zinc coated steel wire.

To prove the inert character of the sealing coating, a wire coated with a sealing coating is immersed in a 1 N HCl or NaOH solution. It has been found that the coating layer of a wire according to the present invention is not dissolving as quickly as an untreated galvanised wire or as a galvanised wire treated in another way, for instance chromating.

Since the applied coating has a thin thickness, the flexibility and deformability of the wire are remained after the coating is applied. A further advantage of the very thin coating of the colored wires according to the present invention is that the wires can be welded.

1. A method of applying a sealing coating on a metal wire, said sealing coating being applied from an aqueous solution comprising a copolymer based on an alkene and acrylic acid.

2. A method according to claim 1, whereby said copolymer is based on ethylene and acrylic acid.

3. A method according to claim 1, whereby said copolymer is based on styrene and acrylic acid.

4. A method according to any one of the preceding claims, whereby said aqueous solution further comprises at least one coloring pigment.

5. A method according to any one of the preceding claims, whereby said sealing coating is applied by dipping said metal wire in said aqueous solution.

6. A method according to any one of claims 1 to 4, whereby said sealing coating is applied by spraying said aqueous solution on said metal wire.

7. A method according to any one of the preceding claims, whereby said sealing coating is applied on a hot metal wire.

8. A method according to any one of the preceding claims, whereby said metal wire is a steel wire.

9. A method according to claim 8, whereby a zinc or zinc alloy coating is applied on said steel wire before the application of said sealing coating.

10. A metal wire coated with a sealing coating, said sealing coating comprises an alkene - acrylate copolymer.

11. A metal wire according to claim 10, whereby said alkene,is ethylene.

12. A metal wire according to claim 10, whereby said alkene is styrene.

13. A metal wire according to any one of claims 10 to 12, whereby said sealing coating further comprises at least one coloring pigment.

14. A metal wire according to any one of claims 10 to 13, whereby said sealing coating has a thickness between 0.1 and 5 μm.

15. A metal wire according to any one of claims 10 to 14, whereby said metal wire is a steel wire.

16. A metal wire according to claim 15, whereby a zinc or zinc alloy coating is applied on said steel wire before the application of the sealing coating.

17. A metal wire according to any one of claims 10 to 16, whereby said zinc or zinc alloy coating has a thickness between 1 and 100 μm.

18. A structure comprising a number of metal wires according to any one of claims 10 to 17.

19. A structure according to claim 18, whereby said structure comprises a welded, woven or braided structure.
